(19) United States
(12) Patent Application Publication
(10) Pub. No.: US 2006/0179641 A1
(43) Pub. Date: Aug. 17, 2006

(54) Liquid composites and fabrication method used in catheter probe endoscopic ultrasound

(76) Inventor: Anny Chun-Hui Soon, Changhua City (TW)

Correspondence Address: EGBERT LAW OFFICES, 412 MAIN STREET, 7TH FLOOR, HOUSTON, TX, 77002, US

(21) Appl. No.: 11/323,682

(22) Filed: Dec. 30, 2005

(30) Foreign Application Priority Data
Jan. 27, 2005 (TW) 0941024455

(51) Int. Cl. H04R 31/00

(52) U.S. Cl. 29/594

(57) ABSTRACT

The method of making a liquid composite and fabrication used in catheter probe endoscopic ultrasound, wherein the composite is made by the mixture of edible powder and water. The fabrication method is to mix the edible powder and water and then stir and heat it to the desired temperature; after cooling, the thick transparent liquid can be used for catheter probe endoscopic ultrasound. Because of the higher viscosity, its speed of flow is slow when it is guided into the human body. Therefore, the dosage of the supply can be greatly reduced, which diminishes the patient's discomfort and side effects. In addition, due to its better suspension, it provides the catheter probe endoscopic ultrasound a more stable medium and better imaging. Overall, it is more applicable and practical than the current mediums being used in catheter probe endoscopic ultrasound.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a liquid composites and fabrication method used in catheter probe endoscopic ultrasound, and more particularly to a transparent liquid made from the mixture of an edible powder and water.

### BACKGROUND OF THE INVENTION

The catheter probe endoscopic ultrasound (C-EUS) is an important tool in the imaging and evaluation of gastrointestinal lesions. The difference between endoscopic ultrasound and regular endoscopy is the added the function of the ultrasound. For this reason, after C-EUS is guided into the GI tract, it not only shows the image of the surface of the organ, but also receives the whole layer stratification through ultrasound. When detecting tumors, C-EUS can show the actual size of the tumor, so that the clinicians can make the correct diagnosis and continue on with further medical procedures. In order to create images, there must be a medium for the acoustic transmission and reflection of sound waves. Today, the medium typically used is de-aerated water. However, this method of application still has the following problems.

Both the motility of the GI tract and the tubular structure of organs such as the esophagus and duodenum quicken the speed of water through the GI tract. For this reason, the water drains quickly away from the imaging field of the endoscopic ultrasound, and must be added constantly in large amounts. However, over-filling the GI tract with large amounts of water creates huge negative impacts for the human body, including nauseating discomfort, and may cause aspiration of water into the lungs, inducing aspiration pneumonia. Due to the negative impacts, people who undergo these procedures may experience a sense of fear and aversion for these procedures, which creates obstacles for the medical procedures unavoidably and makes it hard for both the doctor and the patient.

Moreover, from the quality point of view, the medium is an important factor that affects the quality of the endoscopic ultrasound. Because the water flows fast and lacks stability in the lumen of the GI tract, it causes the ultrasound imaging to be unstable as well, which affects the clarity and sharpness of the image and increases the visual difficulty.

After deliberate design and evaluation based on years of experience in the production, development and design of related products, the inventor has provided the present invention, which overcomes the aforementioned problems, and provides a medium that significantly improves the imaging and efficacy of catheter probe endoscopic ultrasound.

### BRIEF SUMMARY OF THE INVENTION

The present invention provides a transparent liquid composite used in catheter probe endoscopic ultrasound that is more suitable than de-aerated water.

Because the liquid composite of the present invention used in catheter probe endoscopic ultrasound has a thick viscosity, when it is guided into the human body, its speed of flow is slower than water. Therefore, it can remain much longer at the site of instillation, and the dosage of the supply can be greatly reduced. It can diminish the discomfort (such as nausea) and side effects (such as induced aspiration pneumonia) in the people who undergo the procedure, and can effectively ease the patient's fears and discomfort.

In addition to the higher viscosity, the liquid composite of the present invention is also transparent. It is able to provide a better and clearer image in endoscopic ultrasound, thus enhancing the clinician's evaluation of the GI tract.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a brief schematic view of the fabrication method of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

The present invention provides a liquid composite and fabrication method used in catheter probe endoscopic ultrasound, and the primary function of the liquid is to act as the medium between the ultrasound and the object of interest when using catheter probe endoscopic ultrasound. The liquid of the present invention is comprised of edible powder and water, which upon mixing, forms a thickened liquid.

Among them, the edible powder can be: Sodium Carboxymethyl Cellulose (CMC) or Calcium Carboxymethyl Cellulose.

Through the above structure and design, the thick liquid disclosed in the present invention must be transparent so that the video function of the endoscopy is not affected by separation and isolation of the powder. For this reason, the two types of edible powders mentioned above have thickening, emulsifying and transparent properties, which, among all the edible powders, are the types that are more applicable for this invention.

The optimal ratio for Sodium Carboxymethyl Cellulose or Calcium Carboxymethyl Cellulose and water is 1:40 for the best viscosity.

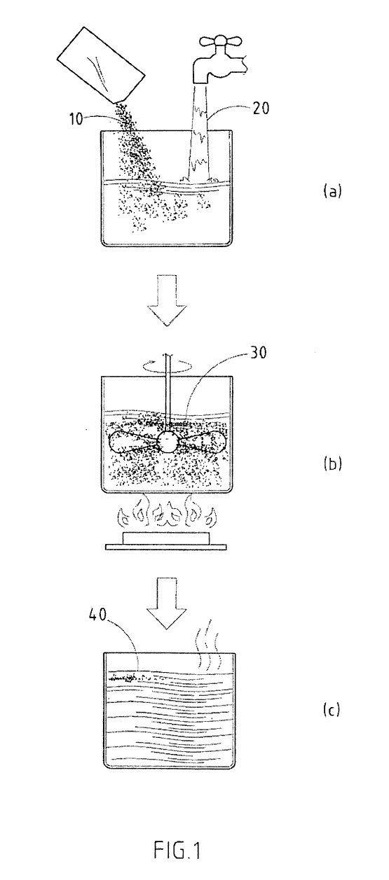

Next, concerning the fabrication of the liquid of the present invention to be used in catheter probe endoscopic ultrasound, it includes the following steps.
a) Mixing the edible powder 10 and water 20 (as shown in (a) in FIG. 1);
b) Stirring up the mixture 30 of the edible powder 10 and the water 20 and heat it up to the desired temperature (as shown in (b) in FIG. 1); and
c) Cooling the mixture to get the desired thick transparent liquid 40 (as shown in (c) in FIG. 1).

From the fabrication mentioned above, the thick transparent liquid can be disinfected after it has been stirred and cooled.

For its usage in catheter probe endoscopic ultrasound, the thick transparent liquid made in the present invention is instilled into the GI tract lumen through a tube which is attached to the outside of the endoscopic ultrasound insertion tube. Thus, the thick transparent liquid may be guided in from the outside and come out the detector end of endoscopic ultrasound at the site of interest within the GI tract.

We claim:

1. A liquid composite and fabrication method used in catheter probe endoscopic ultrasound, comprising the steps of:
making a transparent liquid from a mixture of edible powder and water.

2. The liquid composite defined in claim 1, wherein the edible powder is comprised of Sodium Carboxymethyl Cellulose or Calcium Carboxymethyl Cellulose.

3. A fabrication method for liquid composite used in catheter probe endoscopic ultrasound, the method comprising:
mixing an edible powder and water;
stirring up the mixture of the edible powder and the water and heating the mixture to a desired temperature; and
cooling the mixture to form a desired thick transparent liquid.

4. The fabrication method defined in claim 3, wherein the edible powder is comprised of Sodium Carboxymethyl Cellulose or Calcium Carboxymethyl Cellulose.

5. The fabrication method defined in claim 4, wherein the mixture has an optimal ratio for Sodium Carboxymethyl Cellulose or Calcium Carboxymethyl Cellulose and water is 1:40.

6. The fabrication method defined in claim 3, further comprising the step of:
disinfecting the thick transparent liquid after the stirring step and after the cooling step.
